(19) United States
(12) Patent Application Publication
(10) Pub. No.: US 2020/0386515 A1
(43) Pub. Date: Dec. 10, 2020

(54) MUNITIONS INTERFACE ADAPTER

(71) Applicants: Cantine Armament, Inc., Smyrna, TN (US); Phoenix Avionics Systems, Gaithersburg, MD (US)

(72) Inventors: Christopher Hugh Cantine, Gallatin, TN (US); Robert P. Pfund, Spring Hill, TN (US); Steven L. Kemp, Frederick, MD (US)

(21) Appl. No.: 16/862,049

(22) Filed: Apr. 29, 2020

Related U.S. Application Data
(60) Provisional application No. 62/839,869, filed on Apr. 29, 2019.

(51) Int. Cl. F41F 3/04; F41F 3/052; F41G 7/00; F41G 7/34

(52) U.S. Cl. CPC F41F 3/0406; F41F 3/052; B64C 39/024; F41G 7/346; F41G 7/007

(57) ABSTRACT

A munitions interface adapter including a rail adapter body. A plurality of mounting shoes may be coupled to the rail adapter body, and configured to mechanically couple the rail adapter body to a munitions rail of an installed munitions interface. A fire control connector may be configured to communicatively couple with an installed munitions fire control system. An adapter control interface may be included for adapting fire control signals from the installed munitions fire control system to an adapted munitions fire control signals. One or more adapted munitions deployment fixtures may be positioned on the rail adapter body. The one or more adapted munitions deployment fixtures are configured to retain and deploy one or more adapted munitions.

### CROSS-REFERENCE TO RELATED APPLICATIONS

This applications claims the benefit of U.S. provisional application Ser. No. 62/839,869 entitled “Munitions Interface,” filed on 29 Apr. 2019, the entire contents of both of which are incorporated herein by reference.

### TECHNICAL FIELD

The present invention generally relates to munitions systems, and more particularly relates to adapters for munitions interfaces for allowing a platform to carry different munition types.

### BACKGROUND

A variety of types of munition interfaces are provided to allow munitions to be deployed from a platform, such as a specific aircraft or family of aircraft, ground based vehicles, or fixed launch platforms. The munitions interfaces may generally provide for physical retention of the munitions, as well as some degree of communication between the munition and a launch system, which may often be included with and/or integrated into the platform. For example, physical retention may generally relate to preventing unintended separation for the munition from the platform, and may, in some situations, include maintaining the munition in a desired orientation and/or position relative to the platform. Communication between the munition and/or munition interface and a control system may, at a minimum, include a mechanism for causing the launch, release, or other deployment of the munition from the interface (and thereby from the platform). Communications between the munition and/or the munition interface and the control system may include various addition communications, such as providing targeting information, location information, status information, and the like. It will be appreciated that, due to different physical characteristics and/or capabilities, different munitions will typically require different munitions interfaces to allow for deployment from a given platform. As such, transforming a platform for deployment of one type of munition to deployment of a different type of munition may generally require removing a first munition interface from the platform and installing a different munition interface on the platform. It may also be necessary to replace the control system (e.g., which may be included and/or integrated into the platform). As such, it may often be a complicated and/or time consuming process to make the transformation from one munition interface to a different munition interface.

### SUMMARY

According to an implementation, a munitions interface adapter may include a rail adapter body. A plurality of mounting shoes may be coupled to the rail adapter body, and may be configured to mechanically couple the rail adapter body to a munitions rail of an installed munitions interface. A fire control connector may be configured to communicatively couple with an installed munitions fire control system. An adapter control interface may be provided for adapting fire control signals from the installed munitions fire control system to an adapted munitions fire control signals. One or more adapted munitions deployment fixtures may be positioned on the rail adapter body. The one or more adapted munitions deployment fixtures configured to retain and deploy one or more adapted munitions.

One or more of the following features may be included. The installed munitions interface may include an AGM-114 guided missile interface. The installed munitions interface may include one or more of ah M299 launcher and an M310 launcher. The plurality of mounting shoes may be configured to slidingly receive the rail adapter body on a rail system of the installed munitions interface.

The fire control connector may include a shotgun connector. The adapter control interface may include a first receiver module configured to be communicatively coupled with the installed munitions fire control system for receiving fire control signals from the installed munitions fire control system. The adapter control interface may include a translator module configured to translate the received fire control signals from the installed munitions fire control system into adapted fire control signals. The adapter control interface may include a first transmitter module configured to pass the adapted fire control signals to the one or more adapted munitions. The adapter control interface may include a second receiver module configured to communicatively coupled with the one or more adapted munitions for receiving one or more communication signals from one or more of the one or more adapted munitions. The translator module may be further configured to translated the one or more communication signals into an installed munitions control system communication signal. The adapter control interface may include a second transmitter module configured to transmit the one or more installed munitions control system communication signal to the installed munitions fire control system.

The one or more adapted munitions deployment fixture may include one or more of a bomb release unit, a launch tube, and a munitions rack unit. The one or more adapted munitions may include one or more of an AGM-176 guided munition, a small tactical munition, and an unmanned aerial vehicle.

The munitions interface adapter may include a GPS receiver configured to receive GPS data independently from the installed munitions fire control system. The adapter control interface may be configured to provide the received GPS data to one or more installed adapted munitions. One or more GPS antennas may be located in a forward nose portion of the rail adapter body and may be coupled with the GPS receiver. The one or more GPS antennas located in a forward nose portion of the rail adapter body may be configured to protrude from a wing of an aircraft including the installed munitions system when the rail adapter body is coupled with the installed munitions interface. One or more GPS antennas may be located in a rearward tail portion of the rail adapter body and coupled with the GPS receiver configured to provide improved GPS reception.

According to another implementation, a munitions interface adapter may include a rail adapter body. A plurality of mounting shoes may be coupled to the rail adapter body, and may be configured to mechanically couple the rail adapter body to a munitions rail of an installed munitions interface. The installed munitions interface may include an AGM-114 guided missile launcher. The plurality of mounting shoes may be configured to slidably engage a pair of launch rails of the AGM-114 guided missile launcher. A fire control connector may be configured to communicatively couple with an installed munitions fire control system. An adapter control interface may be provided for adapting fire control signals from the installed munitions fire control system to an adapted munitions fire control signals. One or more adapted munitions deployment fixtures may be positioned on the rail adapter body. The one or more adapted munitions deployment fixtures may be configured to retain and deploy one or more adapted munitions.

One or more of the following features may be included. The one or more adapted munitions deployment fixture may include one or more of a bomb release unit, a launch tube, and a munitions rack unit. The one or more adapted munitions may include one or more of an AGM-176 guided munition, a small tactical munition, and an unmanned aerial vehicle.

The adapter control interface may provide a mapping between fire control signals associated with the installed munitions and fire control signals associated with the adapted munitions. A GPS receiver may be configured to receive GPS data independently from the installed munitions fire control system. The adapter control interface may be configured to provide the received GPS data to one or more installed adapted munitions. One or more GPS antennas may be located in a forward nose portion of the rail adapter body and may be coupled with the GPS receiver. The one or more GPS antennas located in a forward nose portion of the rail adapter body may be configured to protrude from a wing of an aircraft including the installed munitions system when the rail adapter body is coupled with the installed munitions interface. One or more GPS antennas may be located in a rearward tail portion of the rail adapter body and coupled with the GPS receiver configured to provide improved GPS reception.

According to yet another implementation, a munitions interface adapter may include a rail adapter body. A plurality of mounting shoes may be coupled to the rail adapter body, and may be configured to mechanically couple the rail adapter body to a munitions rail of an installed munitions interface. The installed munitions interface may include an AGM-114 guided missile launcher. The plurality of mounting shoes may be are configured to slidably engage a pair of launch rails of the AGM-114 guided missile launcher. A fire control connector may be configured to communicatively couple with an installed munitions fire control system. An adapter control interface may be provided for adapting fire control signals from the installed munitions fire control system to an adapted munitions fire control signals. One or more adapted munitions deployment fixtures may be positioned on the rail adapter body. The one or more adapted munitions deployment fixtures may be configured to retain and deploy one or more adapted munitions. The one or more adapted munitions may include one or more of an AGM-176 guided munition, a small tactical munition, and an unmanned aerial vehicle.

### BRIEF DESCRIPTION OF THE DRAWINGS

FIG. 1 depicts an illustrative example of an M299 four shot Hellfire launcher, according to an example embodiment;

FIG. 2 depicts an illustrative example of an M310 two shot Hellfire launcher, according to an example embodiment;

FIG. 3 depicts an illustrative example embodiment of a munitions interface adapter rail adapter body assembled with a Hellfire interface rail, according to an example embodiment;

FIG. 4 depicts an exploded view of an illustrative example embodiment of a munitions interface adapter, according to an example embodiment;

FIG. 5 depicts an illustrative example embodiment of a rail adapter body, consistent with an example embodiment;

FIG. 6 depicts a functional block diagram of an adapter control interface, according to an example embodiment;

FIG. 7 depicts a functional block diagram of a firmware system that may be implemented in connection with an adapter control interface, according to an example embodiment;

FIG. 8 depicts an illustrative example embodiment of two munitions interface adapter coupled with respective Hellfire interfaces configured with four Griffin Out-of-Tube missiles; according to an example embodiment;

FIG. 9 depicts an illustrative example embodiment of two munitions interface adapters coupled with respective Hellfire interfaces configured with six Pyros munitions; according to an example embodiment;

FIG. 10 depicts an illustrative example embodiment of two munitions interface adapter coupled with respective Hellfire interfaces configured with four Griffin B missiles deployable from common launch tubes, according to an example embodiment; and

FIG. 11 depicts an illustrative example embodiment of a munitions interface adapter enclosed with cowls designed to increase aerodynamics for the munitions interface adapter when using Common Launch Tube (CLT) for Griffin missiles or other munitions utilizing a CLT.

### DETAILED DESCRIPTION

In general, the present disclosure may provide a munitions interface adapter. The munitions interface adapter may be configured to emulate the physical and electrical connections of a munitions interface that is installed on a platform, and allow a different type of munition to be deployed from the platform, e.g., without having to remove the installed munitions interface and replace it with an interface for the different type of munition (e.g., which is not configured to be deployed from the installed munitions interface). The platform may include, but is not limited to, an aircraft (fixed wing and/or rotary wing), a ground based vehicle (such as a wheeled or tracked vehicle), or a fixed ground based platform. Consistent with some implementations, the munitions interface adapter may include a rail adapter body. A plurality of mounting shoes may be coupled to the rail adapter body. The plurality of mounting shoes may be configured to mechanically couple the rail adapter to a munitions rail of the installed munitions interface. Further, a fire control connector may be provided for communicatively coupling with an installed munitions fire control system. An adapter control interface may be provided for adapting fire control signals from the installed munitions fire control system to adapted munitions fire control signals. One or more adapted munitions deployment fixtures may be positioned on the rail adapter body. The one or more adapted munitions deployment fixtures may be configured to retain and deploy one or more adapted munitions.

As generally noted above, a munitions interface adapter consistent with the present disclosure may adapt a munitions interface (e.g., a munitions launcher configured for deploying a particular type of munition) installed on a platform to be capable of deploying another type of munition, which is not compatible with the installed munitions interface. To accomplish this, a munitions interface adapter may be configured to be mechanically coupled to the installed munitions interface and may be communicatively coupled (e.g., via a wired and/or wireless communication interface) with a fire control system for munitions to be deployed from the installed munitions interface. Further, the munitions interface adapter may be configured to retain and deploy the other type of munition (i.e., the adapted munition). As such, the munitions interface adapter may be configured to emulate the physical and electrical (or other communications interface) of the munitions that are designed for use with the installed munitions interface. In this manner, the munitions interface adapter may allow the platform having the installed munitions interface to be quickly configured to utilized the adapted munitions. For example, it may not be necessary to uninstall the installed munitions interface (which may, in some situations, be a relatively complex and time consuming task) in order to configure the platform for use with the adapted munitions.

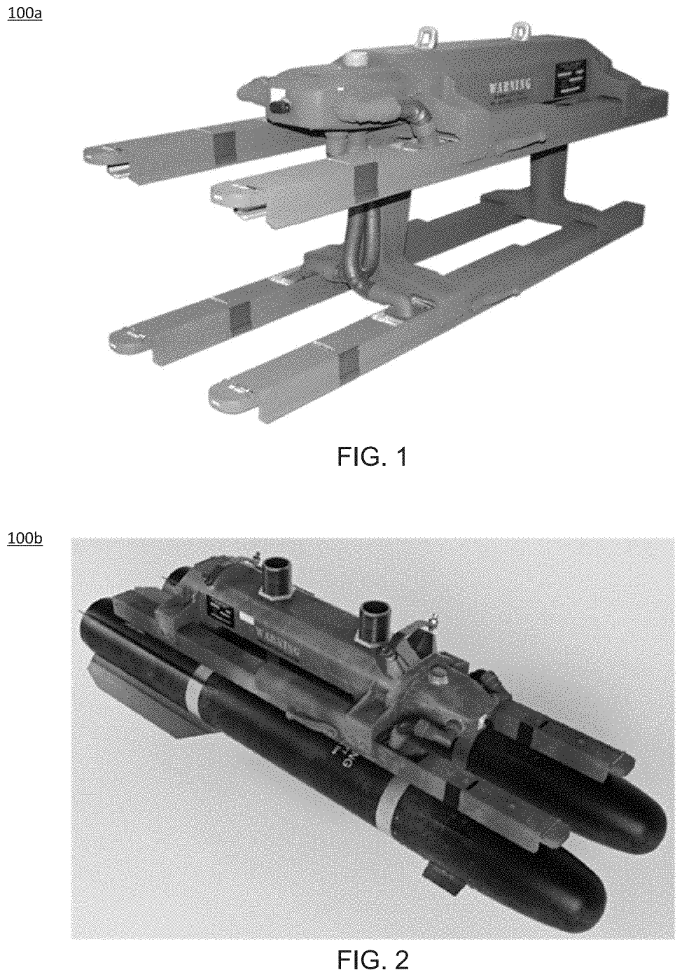

Consistent with an illustrative example embodiment, and referring to FIGS. 1 and 2, the installed munitions interface may include a launcher for an AGM-114 air-to-surface guided missile (e.g., a Hellfire missile). Illustrative examples of launchers for Hellfire missiles may include an M299 four shot Hellfire missile launcher 100a (FIG. 1) and an M310 two shot Hellfire missile launcher 100b (FIG. 2). It will be appreciated that the installed munitions interface may include an interface for a munition other than a Hellfire missile, and/or may include other Hellfire missile launcher variants. In one particular illustrative example, a munitions interface adapter consistent with the present disclosure may be configured for use with a Hellfire missile launcher that is configured for launching Romeo series Hellfire missiles. Further, as is generally known, the Hellfire missile launchers may be installed on a platform, such as a fixed wing and/or a rotary wing aircraft.

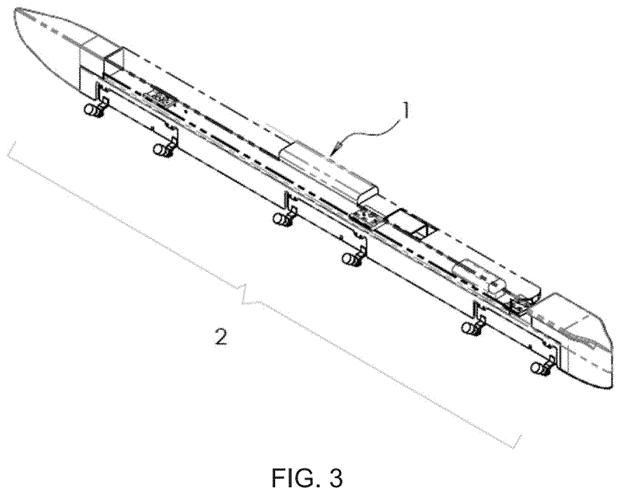

Referring also to FIGS. 3 through 5, and continuing with the illustrative example embodiment of a munition interface adapter configured to adapt a Hellfire missile launcher for use with other munition types (e.g., munitions other than Hellfire missiles), the munition interface adapter 2 may generally include a rail adapter body 2a. The munition interface adapter may further include a plurality of mounting shoes (e.g., mid-mounting shoe 5, rear mounting shoe 6, and forward mounting shoe 9). It will be appreciated that while three mounting shoes are depicted in the illustrated embodiment, a greater or lesser number of mounting shoes may be utilized. The plurality of mounting shoes may be configured to couple the rail adapter body 2a to a munition rail 1 of the installed munitions interface. For example, and continuing with the illustrated example embodiment, the plurality of mounting shoes may have a configuration generally corresponding to the mounting shoes of a Hellfire missile. For example, the mounting shoes may include lateral grooves that may engage corresponding rails on the Hellfire rail interface 1. As such, the munition interface adapter 2 may slidingly engage the corresponding rails of the Hellfire rail interface 1 in a generally similar manner as a Hellfire missile. That is, the munition interface adapter 2 may be mechanically coupled to the Hellfire rail interface by engaging the rear mounting shoe 6 with the rail interface, and sliding the munition interface adapter rearwardly along the rail interface to sequentially engage the mid-mounting shoe 5 and the forward mounting shoe 9. When the mounting shoes are engaged with the rail interface, the munition interface adapter may be physically retained to, and supported by, the rail interface.

The munition interface adapter may further include a fire control connector 3. The fire control connector 3 may be configured to communicatively couple with an installed munitions fire control system. For example, the fire control connector may include a shotgun connector, as is conventionally used with Hellfire missile systems. For example, the installed Hellfire missile launcher may include a first shotgun plug connector portion that may generally be forward facing. The fire control connector 3 of the munition interface adapter may include a second shotgun plug connector, e.g., which may be rearward facing. As such, when the munition interface adapter is fully slidingly engaged on the rails of the Hellfire rail interface, the rearward facing shotgun plug connector of the munition interface adapter may physically and electrically engage the forward facing shotgun plug connector portion associated with the Hellfire launcher. Consistent with such an embodiment, the shotgun connector may be configured to electrically and mechanically interface with the Hellfire launcher for providing electrical connection between the munition interface adapter and the Hellfire launcher and the installed munition fire control system (e.g., a Hellfire missile fire control system). As such, the munition interface adapter may receive electrical power from the platform and may receive and/or pass communications from and/or to the Hellfire missile fire control system (e.g., for providing launch control, targeting information, initialization commands, and the like).

Consistent with some embodiments, the munition interface adapter may include an adapter control interface may be provided for adapting fire control signals from the installed munitions fire control system to an adapted munitions fire control signals. Accordingly, the adapter control interface may adapt and/or translate coding, commands, GPS information and other operational parameters back and forth between the Hellfire fire control system and munitions carried by the munitions interface adapter. In this regard, in addition to avoiding the need to remove the installed munitions interface and replace it with an interface configured for the adapted munitions, it may similarly avoid the need to install a fire control system on the platform that is configured to operate with the adapted munitions to be carried by the munitions interface adapter. In some implementations, the adapter control interface may be capable of interoperability with a plurality of different installed fire control systems and/or capable of interoperability with a plurality of different adapted munitions. For example, an installed fire control system may be manually selected and/or may be automatically detected by the adapter control interface. Similarly, an adapted munition fire control system to be emulated by the adapter control interface may be manually selected, and/or the adapter control interface may be capable of automatically detecting the type and/or characteristics of adapted munitions carried by the munitions interface adapter.

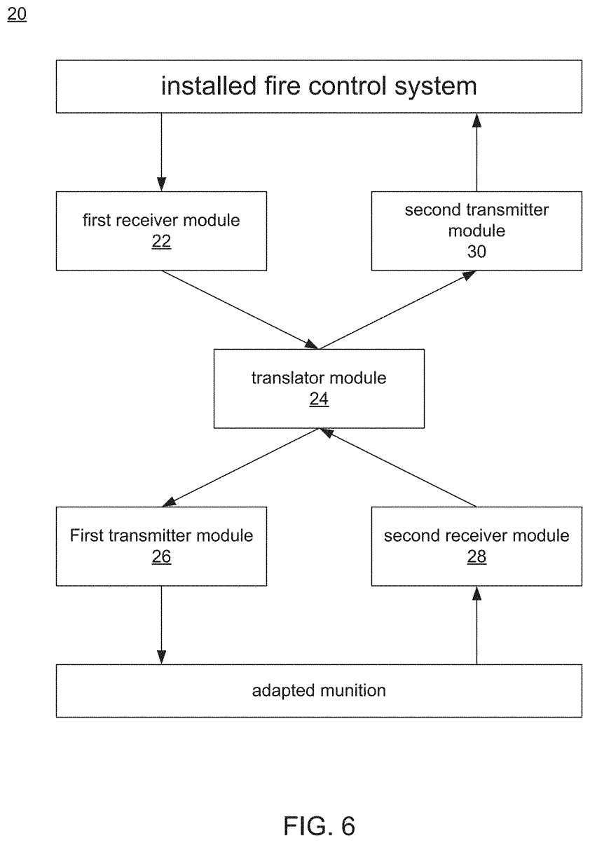

Referring also to FIG. 6, and illustrative example embodiment of an adapter control interface 20 is schematically depicted. As shown, consistent with some illustrative example embodiments, the adapter control interface 20 may include a first receiver module 22 configured to be communicatively coupled with the installed munitions fire control system (e.g., via the shotgun connector and/or other wired or wireless communication interface) for receiving fire control signals from the installed munitions fire control system. The adapter control interface 20 may also include a translator module 24 configured to translate the received fire control signals from the installed munitions fire control system into adapted fire control signals. For example, the translator module 24 may include a mapping of installed munition control signals and adapted munitions control signals. Accordingly the translator module (e.g., which may include any appropriate hardware, firmware, and/or software, such as one or more processors and one or more memory devices coupled with the one or more processors) may translate received signals from the installed munition fire control system into corresponding fire control signals for the adapted munitions. Further, the adapter control interface 20 may include a first transmitter module 26 configured to pass the adapted fire control signals to the one or more adapted munitions. Accordingly, the adapter control interface may emulate an appropriate fire control system for the adapted munitions.

In some embodiments consistent with the present disclosure, in addition/as an alternative to emulating a fire control system appropriate for the adapted munitions, the adapter control interface may allow bidirectional communications between the installed munition fire control system and the adapted munitions. In this manner, the adapter control interface may allow the adapted munitions to emulate munitions configured to be deployed by the installed munitions interface. For example, the adapter control interface 20 may include a second receiver module 28 configured to communicatively coupled with the one or more adapted munitions for receiving one or more communication signals from one or more of the one or more adapted munitions. The translator module 24 may be further configured to translated the one or more communication signals into an installed munitions control system communication signal. The adapter control interface 20 may include a second transmitter module 30 configured to transmit the one or more installed munitions control system communication signal to the installed munitions fire control system. While the adapter control interface has been depicted and described as including a first receiver module, a second transmitter module, a first transmitter module, and a second receiver module, it will be appreciated that one or more of the foregoing modules may be combined, e.g., as one or more transceiver. Additionally, the translator module may further be combined with one or more receiver modules, transmitter modules, and/or transceivers.

As generally discussed herein, a munitions interface adapter consistent with some embodiments of the present disclosure may allow the use of different munitions from a platform that is configured for use with one particular munition. For example, in a non-limiting illustrative example, an embodiment of the munitions interface adapter consistent with the present disclosure may allow the firing of Griffin or Pyros munitions from aircraft configured to fire Hellfire missiles. Further, consistent with some implementations of the present disclosure, the munitions interface adapter may allow the platform to be quickly configured from one munition type to another. In some implementations, and as also generally discussed above, a munitions interface adapter consistent with the present disclosure may include various electronic interfaces, e.g., which may include various software and electronics (e.g., which may, in some embodiments, be embedded in the in the munitions interface adapter itself) which may emulate/translate/pass through coding, commands, GPS information and other conditional parameters back and forth between the installed munitions platform and the adapted munitions carried by the munitions interface adapter.

Continuing with the foregoing, in some embodiments, the electronics (e.g., which may also include software components) and interfaces associated with the munitions interface adapter may be self-contained within the munitions interface adapter. In some embodiments, the electronics (e.g., which may also include software components) may interface with installed munitions fire control systems (e.g., such as Hellfire missile fire control systems, in an illustrative example embodiment). In some embodiments, the electronics (e.g., which may also include software components) may emulates a munition compatible with the installed munitions interface to the installed munitions fire control system (e.g., may emulate a Romeo model Hellfire missile to the installed Hellfire missile fire control system, in an illustrative example embodiment). Consistent with some embodiments, the electronics (e.g., which may also include software components) may support a single adapted munition type and/or may support multiple adapted munitions/packages. Illustrative examples of some adapted munitions that may be supported may include, but are not limited to, Raytheon Griffin A, Griffin B, Griffin Out-Of-Tube, or Pyros as well as other deployable and/or non-deployable packages, such as aerial launched or deployed drones (e.g., Coyote UAS from Raytheon, and or other tube launched or tubeless deployed unmanned aircraft). Consistent with an illustrative example embodiment in which the installed munitions fire control system may be compatible with a Romeo series Hellfire missile, the electronics (e.g., which may also include software components) may utilize Romeo Transfer Alignment and Targeting data to initialize GPS based weapons. Consistent with some embodiments, the electronics (e.g., which may also include software components) may be configurable to include an embedded GPS receiver and one or more GPS antennas allowing establishment of ‘Own GPS Position’ or to use weapon GPS data for that purpose. Consistent with some embodiments, the electronics (e.g., which may also include software components) may be compatible with installed munition power sources for operational power.

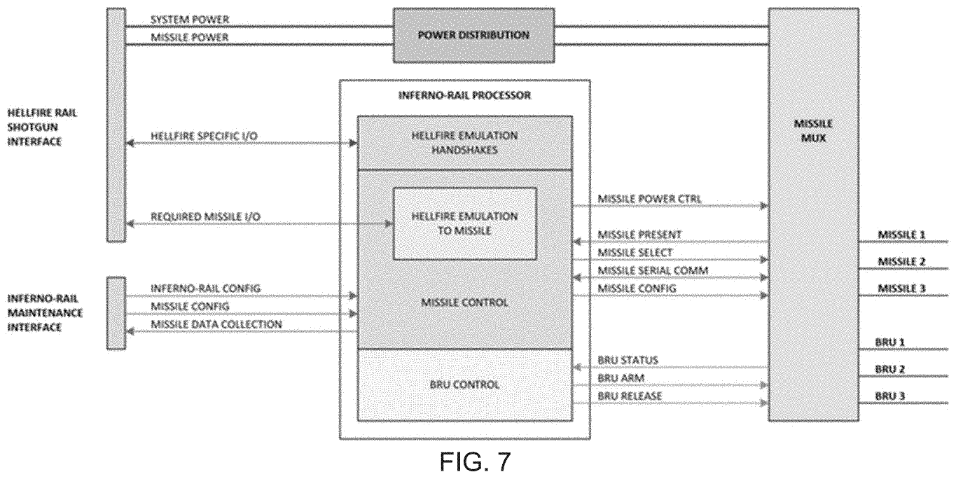

Referring also to FIG. 7 a functional block diagram of an illustrative example embodiment of a hardware/firmware/software system that may be used in connection with a munitions interface adapter consistent with the present disclosure is shown. In the illustrated example firmware system the munitions interface adapter is designated as “Inferno-Rail.” Further, in the illustrated example embodiment, the system is configured for use with a Hellfire missile installed munition interface and fire control system. The depicted illustrative example hardware/firmware/software system may generally include six main sub-systems.

1. Power Distribution:
Two main sources of power may be received from the Hellfire Rail Shotgun connector and may be utilized for system and missile power throughout the Inferno-Rail.

2. Hellfire Emulation Handshakes:
Hellfire specific signals may be received from the Hellfire Rail Shotgun connector, may be controlled, and may be sent back out as outputs to satisfy the requirements of the Hellfire system.

3. Hellfire Emulation to Missile:
Hellfire missile commands may be received from the Hellfire Rail Shotgun connector and may be converted as necessary for use with the Griffin, Pyros, or other ordinance installed on the Inferno-Rail.

4. Missile Control:
Upon conversion of the Hellfire signals to those utilized by the ordinance installed on the Inferno-Rail, appropriate discrete signals and serial communication may be sent to, and received from, the Missile Multiplexer (MUX) system. In addition, a maintenance interface on the Inferno-Rail may allow for configuration of the missile and Inferno-Rail and provides a means to collect missile data.

5. BRU Control:
The BRU Control module may receive BRU status inputs and may send commands to the BRU or the Common Launch Tube (CLT) during the launch sequence to arm the unit and release the missile.

6. Missile MUX:
The Missile Multiplexer may receive all commands, signals, and power from the Inferno-Rail system and may route them to the selected missile installed on the Inferno-Rail.

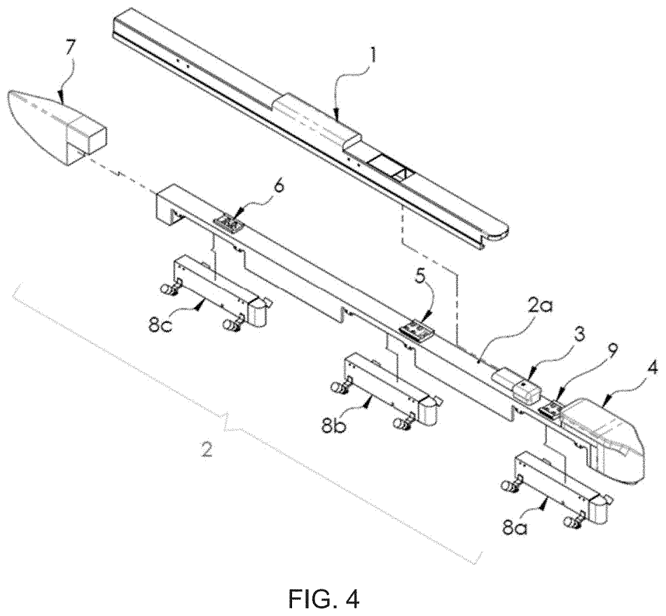

Consistent with the present disclosure, the munition interface adapter may include one or more adapted munitions deployment fixtures, which may be positioned on the rail adapter body. The one or more adapted munitions deployment fixtures may be configured to retain and deploy one or more adapted munitions. Consistent with various embodiment, the one or more adapted munitions deployment fixture may include one or more of a bomb release unit, a launch tube, and a munitions rack unit. For example, as shown in the illustrated example embodiment in FIGS. 3 and 4, the one or more adapted munitions deployment fixture may include one or more bomb release units 8a-c. Additionally, as shown in the illustrated example embodiment of FIG. 10, the one or more adapted munitions deployment fixture may include one or more launch tubes, such as, but not limited to common launch tubes, Raytheon A tubes, Raytheon B tubes, or the like. It will be appreciated that other adapted munitions deployment fixtures may be utilized depending upon the type and/or configuration of the adapted munitions. Further, it will be appreciated that a combination of different adapted munitions deployment fixtures may be utilized in connection with a munitions interface adapter consistent with the present disclosure.

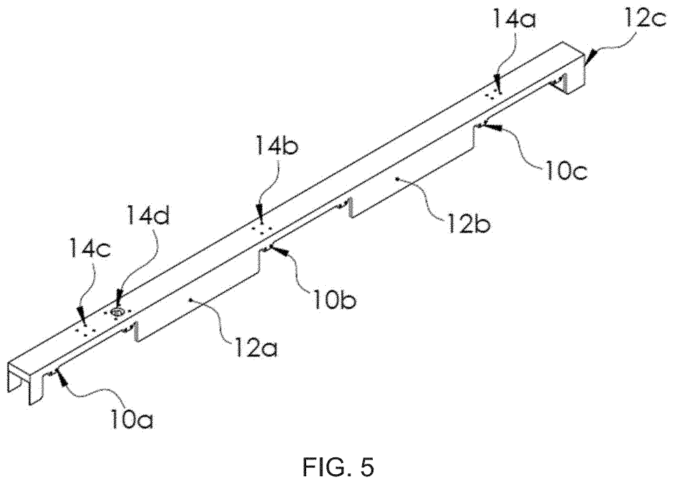

As shown, e.g., in FIG. 5, the rail adapter body 2a may include one or more mounting locations 10a-10c for mounting the adapted munitions deployment fixtures. In some implementations, each mounting location 10a-10c may be configured for physically mounting the adapted munitions deployment fixtures to the rail adapter body. Further, in some implementations, the rail adapter body may include one or more electrical housing features (e.g., electrical mounting housings 12a-12c). In some embodiments, the electrical housings 12a-12c may each be configured for providing electrical connection between one or more of the shotgun connector, GPS hardware, the adapter control interface, an adapted munition deployment fixture, and/or an adapted munition carried by the munitions interface adapter. As also shown in the illustrative example of FIG. 5, the rail adapter body 2a may include mounting locations for the mounting shoes 5, 6, and 9. Further, the rail adapter body 2a may include a mounting location 14d for the shotgun connector.

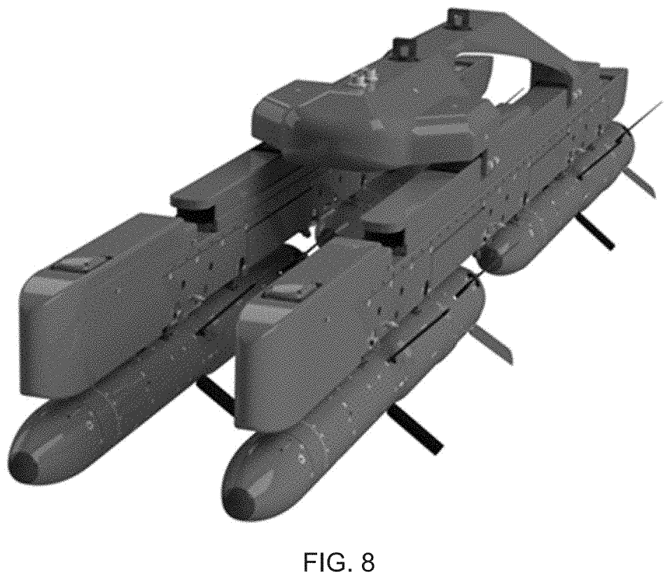

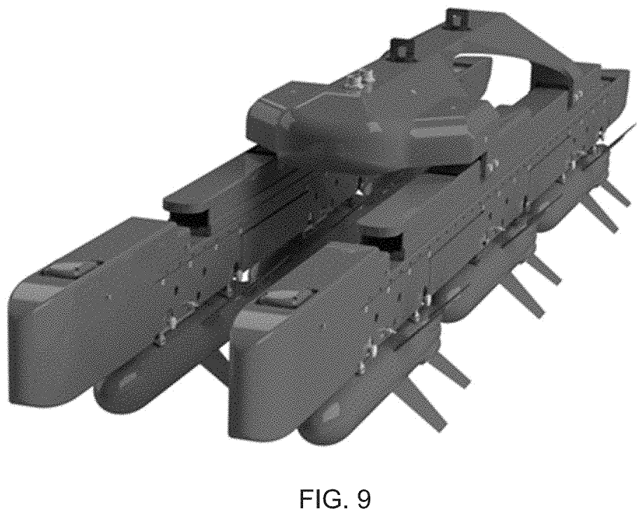

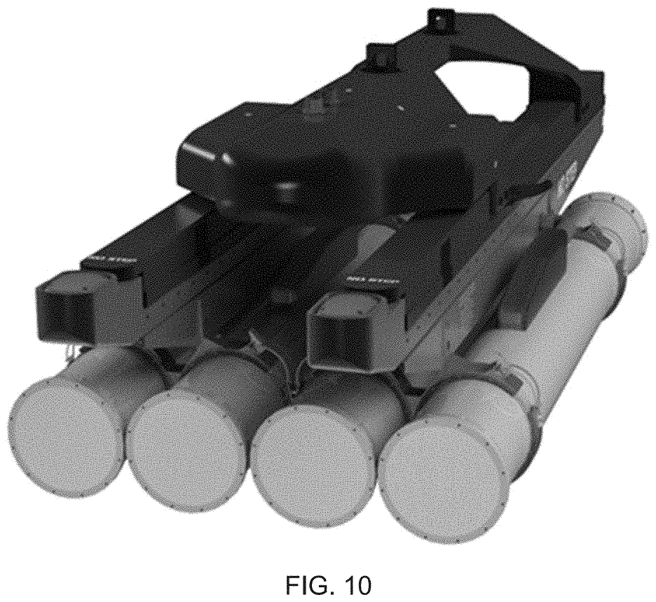

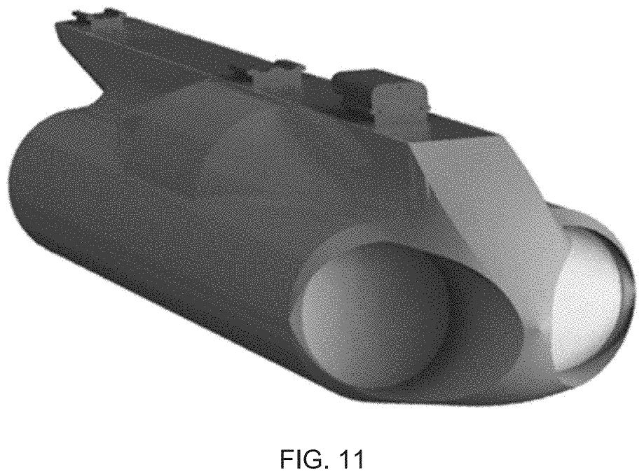

Consistent with some example embodiments, the one or more adapted munitions may include one or more of an AGM-176 guided munition, a small tactical munition, and an unmanned aerial vehicle. For example, as shown in FIG. 8, the adapted munitions may include Raytheon Griffin Out-of-Tube missiles. For example, as shown in FIG. 9, the adapted munitions may include Raytheon Pyros munitions. Further, and as shown, e.g., in FIG. 10, the adapted munitions may include Raytheon Griffin B tube launched missiles. Various additional and/or alternative adapted munitions may also be utilized, such as unmanned aerial vehicles (e.g., Raytheon Coyote Unmanned Air System, etc.). As shown in FIG. 11, consistent with some illustrative example embodiments, a munitions interface adapter consistent with the present disclosure may include cowls which may at least partially enclose the munitions interface adapter and/or adapted munitions deployment fixtures associated therewith. Consistent with some such embodiments, the cowls may be designed to increase aerodynamics for the munitions interface adapter when using Common Launch Tube (CLT) for Griffin missiles or other munitions utilizing a CLT.

It will be appreciated that still further tube, or tubeless deployed munitions may be utilized in connection with a munitions interface adapter consistent with the present disclosure.

In some embodiments consistent with the present disclosure, the munitions interface adapter may include a GPS receiver configured to receive GPS data independently from the installed munitions fire control system. In some such implementations, the adapter control interface may be configured to provide the received GPS data to one or more installed adapted munitions. Consistent with the illustrated example embodiment, one or more GPS antennas may be located in a forward nose portion (e.g., nose cone 4, depicted in FIG. 4) of the rail adapter body. The one or more GPS antennas located in the forward nose portion may be coupled with the GPS receiver. Consistent with such an embodiment, the one or more GPS antennas located in the forward nose portion may be configured to protrude from a wing of an aircraft including the installed munitions system when the rail adapter body is coupled with the installed munitions interface. Further, in some embodiments, one or more GPS antennas may be located in a rearward tail portion (e.g., tail cone of the rail adapter body and coupled with the GPS receiver configured to provide improved GPS reception.

While the present disclosure has generally been described in the context of system for adapting a Hellfire missile rail interface for use with other munitions types, such description has been presented for the purpose of illustration. It will be appreciated that a munitions interface adapter consistent with the present disclosure may be utilized for adapting a variety of different munitions interfaces for deploying various other munition types. As such, the present disclosure is considered to be broadly directed at any munitions interface types.

Herein general description of illustrative example embodiments is provided. Such illustrative example embodiments describe implementations utilizing Griffin and/or Pyros munitions. However, it will be appreciated that the concepts herein are equally applicable to other munitions, as well as to other packages that may be carried by and/or effectuate launches via Hellfire rail interfaces. In some embodiments, the described interface/adapter may further be used in connection with Raytheon A Tube and/or Raytheon B Tube deployable munitions or vehicles. Further, in some embodiments, the described interface/adapter may be used in connection with munitions, vehicles, or packages that are carried/deployed by other tube or rack units. As such, the description herein should be understood as being illustrative rather than limiting.

A variety of features of the have been described herein. However, it will be appreciated that various additional features and structures may be implemented in connection with a munitions interface adapter according to the present disclosure. Further, additional features and details may be depicted in the figures that may not explicitly be described in the detailed description. However, such features and details should be understood as being included within the scope of the present disclosure. Additionally, the various features described herein may be implemented in a variety of combination and sub-combination, including less than all of the described features, and/or some or all of the described features in combination will additional features not specifically detailed in the present disclosure. As such, the features and attributes described herein should not be construed as a limitation on the present disclosure.

What is claimed is:

1. A munitions interface adapter comprising:
a rail adapter body;
a plurality of mounting shoes coupled to the rail adapter body, and configured to mechanically couple the rail adapter body to a munitions rail of an installed munitions interface;
a fire control connector configured to communicatively couple with an installed munitions fire control system;
an adapter control interface for adapting fire control signals from the installed munitions fire control system to an adapted munitions fire control signals; and
one or more adapted munitions deployment fixtures positioned on the rail adapter body, the one or more adapted munitions deployment fixtures configured to retain and deploy one or more adapted munitions.

2. The munitions interface adapter according to claim 1, wherein the installed munitions interface includes an AGM-114 guided missile interface.

3. The munitions interface adapter according to claim 2, wherein the installed munitions interface includes one or more of ah M299 launcher and an M310 launcher.

4. The munitions interface adapter according to claim 1, wherein the plurality of mounting shoes are configured to slidingly receive the rail adapter body on a rail system of the installed munitions interface.

5. The munitions interface adapter according to clam 1, wherein the fire control connector includes a shotgun connector.

6. The munitions interface adapter according to claim 1, wherein the adapter control interface includes:
a first receiver module configured to be communicatively coupled with the installed munitions fire control system for receiving fire control signals from the installed munitions fire control system;
a translator module configured to translate the received fire control signals from the installed munitions fire control system into adapted fire control signals; and
a first transmitter module configured to pass the adapted fire control signals to the one or more adapted munitions.

7. The munitions interface adapter according to claim 6, wherein the adapter control interface further includes:
a second receiver module configured to communicatively coupled with the one or more adapted munitions for receiving one or more communication signals from one or more of the one or more adapted munitions;
the translator module is further configured to translated the one or more communication signals into an installed munitions control system communication signal; and
a second transmitter module configured to transmit the one or more installed munitions control system communication signal to the installed munitions fire control system.

8. The munitions interface adapter according to claim 1, wherein the one or more adapted munitions deployment fixture includes one or more of a bomb release unit, a launch tube, and a munitions rack unit.

9. The munitions interface adapter according to claim 1, wherein the one or more adapted munitions include one or more of an AGM-176 guided munition, a small tactical munition, and an unmanned aerial vehicle.

10. The munitions interface adapter according to claim 1, further comprising a GPS receiver configured to receive GPS data independently from the installed munitions fire control system, and wherein the adapter control interface is configured to provide the received GPS data to one or more installed adapted munitions.

11. The munitions interface adapter according to claim 10, comprising one or more GPS antennas located in a forward nose portion of the rail adapter body and coupled with the GPS receiver, the one or more GPS antennas located in a forward nose portion of the rail adapter body being configured to protrude from a wing of an aircraft including the installed munitions system when the rail adapter body is coupled with the installed munitions interface.

12. The munitions interface adapter according to claim 11, further comprising one or more GPS antennas located in a rearward tail portion of the rail adapter body and coupled with the GPS receiver configured to provide improved GPS reception.

13. A munitions interface adapter comprising:
a rail adapter body;
a plurality of mounting shoes coupled to the rail adapter body, and configured to mechanically couple the rail adapter body to a munitions rail of an installed munitions interface;
wherein the installed munitions interface includes an AGM-114 guided missile launcher and wherein the plurality of mounting shoes are configured to slidably engage a pair of launch rails of the AGM-114 guided missile launcher;
a fire control connector configured to communicatively couple with an installed munitions fire control system;
an adapter control interface for adapting fire control signals from the installed munitions fire control system to an adapted munitions fire control signals; and
one or more adapted munitions deployment fixtures positioned on the rail adapter body, the one or more adapted munitions deployment fixtures configured to retain and deploy one or more adapted munitions.

14. The munitions interface adapter according to claim 13, wherein the one or more adapted munitions deployment fixture includes one or more of a bomb release unit, a launch tube, and a munitions rack unit.

15. The munitions interface adapter according to claim 13, wherein the one or more adapted munitions include one or more of an AGM-176 guided munition, a small tactical munition, and an unmanned aerial vehicle.

16. The munitions interface adapter according to claim 13, wherein the adapter control interface provides a mapping between fire control signals associated with the installed munitions and fire control signals associated with the adapted munitions.

17. The munitions interface adapter according to claim 13, further comprising a GPS receiver configured to receive GPS data independently from the installed munitions fire control system, and wherein the adapter control interface is configured to provide the received GPS data to one or more installed adapted munitions.

18. The munitions interface adapter according to claim 17, comprising one or more GPS antennas located in a forward nose portion of the rail adapter body and coupled with the GPS receiver, the one or more GPS antennas located in a forward nose portion of the rail adapter body being configured to protrude from a wing of an aircraft including the installed munitions system when the rail adapter body is coupled with the installed munitions interface.

19. The munitions interface adapter according to claim 18, further comprising one or more GPS antennas located in a rearward tail portion of the rail adapter body and coupled with the GPS receiver configured to provide improved GPS reception.

20. A munitions interface adapter comprising:
a rail adapter body;
a plurality of mounting shoes coupled to the rail adapter body, and configured to mechanically couple the rail adapter body to a munitions rail of an installed munitions interface;
wherein the installed munitions interface includes an AGM-114 guided missile launcher and wherein the plurality of mounting shoes are configured to slidably engage a pair of launch rails of the AGM-114 guided missile launcher.
a fire control connector configured to communicatively couple with an installed munitions fire control system;
an adapter control interface for adapting fire control signals from the installed munitions fire control system to an adapted munitions fire control signals; and
one or more adapted munitions deployment fixtures positioned on the rail adapter body, the one or more adapted munitions deployment fixtures configured to retain and deploy one or more adapted munitions, wherein the one or more adapted munitions include one or more of an AGM-176 guided munition, a small tactical munition, and an unmanned aerial vehicle.
